(19) United States
(12) Patent Application Publication
(10) Pub. No.: US 2005/0021436 A1
(43) Pub. Date: Jan. 27, 2005

(54) Method and system for predicting changes in value of financial assets

(76) Inventor: Bartholomew F. Dowling, Cambridge (GB)

Correspondence Address: FENWICK & WEST LLP, SILICON VALLEY CENTER, 801 CALIFORNIA STREET, MOUNTAIN VIEW, CA, 94041, US

(21) Appl. No.: 10/841,247

(22) Filed: May 6, 2004

(30) Foreign Application Priority Data
May 7, 2003 (GB) GB0310454.4

(51) Int. Cl. G06F 17/60

(52) U.S. Cl. 705/36

(57) ABSTRACT

A method of predicting changes in a value associated with at least one financial asset wherein information relevant to the asset is processed by an adaptive bioinformatics-based evolutionary process and the information relevant to the asset is modelled as a plurality of informational components, the informational components are combined into a plurality of sequences and the sequences are combined into an agglomeration of sequences.

### FIELD OF THE INVENTION

The present invention relates to the field of investment services. More particularly, the present invention relates to a method and system for predicting changes in value of financial assets using bioinformatics/evolutionary principles which can then be used to select assets for investment purposes.

### BACKGROUND OF THE INVENTION

An investor seeking to select an asset for investment is faced with an overwhelming array of information. This information includes analytical tools or methods, investment research, analyst opinions, publications, reports from news services and much more. At the very start of the selection process an investor must choose what information is relevant to the asset in question. To do so, an investor may draw upon certain analytical tools from the several available models to define the actual relationship between information input and asset performance output. Such analytical techniques include for example, time-series methods (both linear and non-linear), neural networks, and cross-sectional analyses (some of these analytical techniques will be discussed in greater detail below).

Such ‘information input’/‘asset performance output’ methods typically require some expertise on behalf of the investor in selecting which variables to use so as to minimize the time and effort involved in the relationship search process. Further, certain techniques—such as time series methods—typically require some expertise on behalf of the investor in discerning the correct functional form of the relationship between information input and asset performance output. That is, investors need to know not only the correct elements that have the potential to influence each other from the vast array of information at their fingertips, but they must also know the specificity of this relationship.

More detailed discussion of the typical requirements of analytical asset selection methods may be found in the following publications, which are incorporated herein by reference: (i) Mills, T. C. (1993) The Econometric Modelling of Financial Time Series, Cambridge University Press, Cambridge. (ii) Hamilton, J. D (1994) Time Series Analysis, Princeton University Press, Princeton. (iii) Beltratti, A. Margarita, S. and Terna, P. (1996) Neural Networks for Economic and Financial Modeling, International Thomson Computer Press, London.

The requirement for specialized knowledge in knowing both how variables are related to each other and the precise nature (functional form) of this relationship has necessitated a plethora of research into this particular area of financial management in an attempt to inform investors. Paradoxically these efforts have added to the information overload investors presently face rather than having alleviated the problem. Indeed, management of information overload is now one of the most common problems investors face as they attempt to select assets for investment purposes.

### SUMMARY OF THE INVENTION

According to a first aspect of the invention there is provided a method of predicting changes in a value associated with at least one financial asset wherein information relevant to the asset is processed by an adaptive bioinformatics-based evolutionary process and the information relevant to the asset is modelled as a plurality of informational components, the informational components are combined into a plurality of sequences and the sequences are combined into an agglomeration of sequences.

The traditional way information relevant to an asset has been treated in financial markets is known as a ‘random walk’. That is, changes in the information (sometimes referred to as information arrival) is said to be the outcome of a random process—throwing dice so to speak—and is therefore impossible to predict. Further, conditional upon this assumption is the belief that there are no associations between various segments of information across time—in short, information arrival is assumed to be Independent and Identically Distributed (IID). An advantage of the present method is that it allows changes in the value of a financial asset to predicted by imposing a structure on the information relevant to the or each asset. The imposition of such structure may allow searches to be performed within historical data in order that future performance may be predicted based upon current information relevant to the or each asset.

The plurality of informational components, the plurality of sequences and the agglomeration of sequences used by the method may respectively likened to bases, genes and dna. The historical data mapped by the method may be thought of as informational genome—the equivalent of the human genome. Thus, the method may be thought of as imposing the structure of bioinformatics onto financial data.

The method may also comprise the use of evolutionary algorithms upon data arranged according to bio-informatic principles. This may be to identify ordered clusters of associative information commensurate with certain asset price outcomes and to make probabilistic projections of such outcomes known, generally via user software.

The method may also comprise the use of evolutionary algorithms upon data arranged according to bio-informatic principles to identify ordered clusters of associative information commensurate with certain asset price outcomes and allow for the adaptive nature of financial agents in responding to this information before making probabilistic projections of certain asset price outcomes known, generally via user software.

According to a second aspect of the invention there is provided a computer system arranged to predict changes in a value associated with at least one financial asset, the system comprising a memory arranged to store historical data structured according to bio-informatic principles with information relevant to an asset being modelled as a plurality of informational components, the informational components being combined into a plurality of sequences and the sequences being combined into an agglomeration of sequences, the system further comprising a processor arranged to run an evolutionary algorithm which processes the historical data in order predict the change in value of the at least one asset.

According to a third aspect of the invention there is provided a data structure providing information relevant to a financial asset, the data being structured as a series of informational components, with informational components being combined into a plurality of sequences and the sequences being combined into a plurality of agglomerations of sequences.

According to a fourth aspect of the invention there is provided a machine readable medium containing instructions which when read by a computer cause that computer to perform the method of the first aspect of the invention.

According to a fifth aspect of the invention there is provided a machine readable medium containing instructions which when read by a computer cause that computer to function as the computer system of the second aspect of the invention.

According to a sixth aspect of the invention there is provided a machine readable medium containing instructions providing the data structure of the third aspect of the invention.

According to a seventh aspect of the invention there is provided a financial asset predictive system comprising:
a memory in which a neural network representing the mutual relationships between information bytes based upon past events,
a processor for generating for each information byte associative information bytes from combining relationships defined in the memory to predict further relationships between information bytes,
event input means for receiving an information byte input by a user; and
and output means to output information to the user predicting the effect of said input information byte on other financial assets.

The skilled person will appreciate that the term neural network is a broad one and covers many different classes of techniques for processing data in a pseudo artificially intelligent manner. Once such class of techniques is the so-called genetic algorithm sometimes known as evolutionary computation,

According to an eighth aspect of the invention there is provided a method for predicting the effect of a chosen information byte comprising:
generating a series of associated information bytes linked to the chosen information byte by using an algorithm which creates analogies to the relationships defined in a neural network based upon past events,
using the neural network to predict the probabilities of the effects of each associated information byte upon other information bytes; and
generating from these probabilities user output reports to predict the effect of the chosen information byte on other information bytes.

The machine readable medium of the any of the above aspects of the invention may be any one or more of the following non-exhaustive list: a floppy disk; a CDROM/RAM; a DVD ROM/RAM (including +R/RW, −R/RW); any form of magneto optical disk; a hard drive; a memory; a transmitted signal (including an internet download, file transfer, or the like); a wire; or any other form of medium.

In embodiments of the invention, information is treated as the outcome of an evolutionary process. Strands of information. or agglomerations of sequences, —themes—are made up of individual segments, or sequences, (memes) which are made up of even smaller informational components (bytes). The way this information combines is similar to the way that genes build up human DNA. In viewing information as an evolutionary process, embodiments of the invention are able to draw upon existing mathematical techniques from spheres such as bioinformatics and the class of neural network algorithms known as evolutionary algorithms as a starting point. These methods may then be adapted to allow for the constantly evolving/associative nature of information itself and in addition, introduces certain ancillary elements to the overall technique to allow for financial market adaptive behaviour. An analytical tool may result that requires no prior knowledge on behalf of the investor regarding either the relationship between or the specificity of functional form for information input and investment performance output in their asset selection process—thereby helping to overcome the problem of information overload that investors commonly face.

By adopting a bioinformatics-based evolutionary approach toward information in financial markets, rather than the ‘random walk’ of the prior art, it may be possible to build associations between information segments (i.e. sequences) across time. That is, informational components may be combined over time to form larger information strands, or sequences, sometimes known as ‘memes’. These ‘memes’ may be combined into larger informational entities to form agglomerations of sequences, sometimes referred to as ‘themes’ and ‘themes’ may be combined to enforce swings in overall ‘market sentiment’. It is the way this information combines that influences asset price behaviour so allowing the prediction of the microformation of ever-larger informational components. As such it is advantageous in understanding the dynamics between information input and asset price output.

Evolutionary algorithm techniques based upon data structured according to bio-informatic principles may be used to look for combinations of binary encoded informational components—strings—that are generally associative with emergent sequences (memes) and/or then agglomeration of sequences (themes) and are thus predictive of certain asset price outcomes. In doing so, the order of arrival of information components may be considered within the algorithm—as consistent with genetic algorithm processing—as is the associative potential between various information components (bytes).

By looking at binary encoded strings of information in this evolutionary manner, it is possible to take into regard both the contemporaneous and latent characteristics of information itself. That is, a given information component (byte) may have a particular implication for asset prices when it is initially revealed but a totally different implication when combined with other informational components (bytes) with the passage of time. In essence, the same informational component (byte) may be represented at different points along the binary encoded information string with different predictive effects upon asset prices. This latent/contemporaneous ability to assess the impact of information on an array of target variables (in our case, asset prices) is a useful attribute of embodiments of the invention.

In adopting such an approach, embodiments of the invention make the contribution of looking beyond specific information signal inputs in building larger informational entities by also considering similar behaving information signals. That is, each informational component (byte) may first be categorized into specific groups according to common aggregative nomenclature (such as index classifications) and behavioural characteristics (such as risk/return dynamics). Information strings may then be built using specific informational components (bytes) and may also be built using various combinations of similar informational components (bytes). This is advantageous because an assessment of the true probabilities of certain asset price outcomes can be made. It should be possible to provide the user not only with information about perfect matches between the market's ‘informational genome’ and asset prices, but also similar matches.

For example, rather than investigating whether a relationship exists between US Gross Domestic Product and US Equity performance on a specific information string basis, the search algorithm may first identify what ordered information is associative with US GDP. It may then relate this entire class of information to US Equity performance. Thus it may be able to form a better probability assessment of the impact of US GDP on US Equity performance as it makes an assessment of how for instance, weaker investment (a component of US GDP) may be used as a proxy in investors minds for actual US GDP. In doing so, embodiments of the invention make the contribution of looking for not just an identical sequence of ordered informational components (bytes) in building the market's informational genome but also similar sequences of ordered informational components (bytes).

In essence, embodiments of the invention may be thought of as looking at the explanatory power of various combinations of informational components (bytes) along the market's informational genome.

Some embodiments of the invention may go further in allowing for certain informational components (bytes) to replaced by other informational components (bytes) carrying similar characteristics. An advantage of such an approach is that a more comprehensive assessment of how information can combine in a manner commensurate with evolutionary principles to influence asset price dynamics as it takes explicitly into consideration the fact that history generally never repeats itself exactly twice. Rather, it may be that a combination of similar—but not identical—informational components (bytes) is sufficient to have a predictive influence upon asset price dynamics. Thus, embodiments of the invention may be able to expand the array of interpretive behaviour stemming from any one information set. This approach toward understanding the microfoundation structure of information based upon bioinformatics/evolutionary principles is totally different from current ‘state of the art’ evolutionary algorithms as they are presently used in the field of finance. See for instance, (i) Refenes, A. P. (ed) (1995) Neural Networks in the Capital Markets, John Wiley & Sons, Chichester. (ii) Trippi, R. R. and Turban, E. (eds) (1996) Neural Networks in Finance and Investing. Using Artificial Intelligence to Improve Real-World Performance, Irwin Professional Publishing, Chicago.

In addition, embodiments of the invention may also take into consideration the adaptive nature of financial markets in making its asset price performance projections. For example, the response function of financial agents may alter through time as they respond to certain (associative) information bytes simply because they learn that certain associative information bytes (memes) will generally result in specific asset price outcomes as these ‘memes’ eventually form into ‘themes’. An advantage of such an approach is that financial agents may thus have a tendency to respond faster to the appearance of a given meme by entering the market and altering the price of certain assets simply because through time they are ‘learning by doing’ that certain ‘memes’ generally manifest into certain ‘themes’.

This adaptive nature of financial market participants may be taken into account in embodiments of the invention before making a final asset selection projections via an iterative procedure. In one embodiment the iterative procedure is a two stage one wherein stage 1 identifies the ordered classes of associative information and stage 2 then calculates how the functional form of how this input signal/asset price output relationship is changing through time. Such an ex-ante looking 2 stage iterative procedure of ordered associative information signal search followed by an adaptive response function calculation is different from current ‘state of the art’ evolutionary algorithms as they are presently used in the field of finance.

See for instance, (i) Refenes, A. P. (ed) (1995) Neural Networks in the Capital Markets, John Wiley & Sons, Chichester. (ii) Trippi, R. R. and Turban, E. (eds) (1996) Neural Networks in Finance and Investing: Using Artificial Intelligence to Improve Real-World Performance, Irwin Professional Publishing, Chicago.

### BRIEF DESCRIPTION OF THE DRAWINGS

A system and method for predicting changes in value of a financial asset in accordance with an embodiment of the invention will now be described, with reference to and as illustrated in the accompanying drawings in which

FIG. 1 shows a computer system arranged to provide an embodiment of the present invention;

FIG. 2 is a flow diagram of the method and system:

FIG. 3 is an overall schematic representation and an example of a typical cross-sectional representation of a 3-D informational radix Figure generated by the system; and,

FIG. 4 is a 2-D projection of the 3-D informational radix shown in FIG. 2;

FIG. 5 is a sample of a typical result sheet generated by the system.

### DETAILED DESCRIPTION OF THE PREFERRED EMBODIMENT

In the prior art, if an investor wishes to determine the impact of a particular ‘byte’ of information—for instance, an upward revision in US GDP—on investment performance, they would need to opt for one of the following approaches.

i) Time-Series Analysis

Here the onus of expertise is very much on the investor.

a) First they would need to specify the ‘dependent variable’ in the sense that they would need to select from a near infinite range of alternatives the correct array of possible investments whose performance is somehow related to US GDP;

e.g. ComapnyA's Stock Price=f(US GDP).

The are literally millions of permutations to choose from. Selecting the right alternative is often referred to as more of an ‘art than a science’.

b) Next, they would need to correctly surmise the functional form of the relationship between the asset they have selected and US GDP—again, there is a large array of possibilities

e.g. CompanyA's Stock Price=α+β(US GDP)².

c) Finally, they would require considerable expertise in interpreting the output of any time series analysis in the sense that there are a battery of diagnostic tests from which the strength of the association between the dependent variable (in our example, Company A's Stock Price) and the independent variable (in our example, US GDP) are drawn. Further, if the relationship itself is actually changing through time as markets adapt (in the sense that Company A's share price responds more rapidly to any revision to US GDP as investors learn to better interpret certain information signals) then the battery of diagnostic tests becomes much more extensive.

ii) Neural-Network Techniques

Here there is considerably less onus on the investor in terms of prior expertise. In particular, step (b) in the above time-series example is effectively skipped as the genetic algorithm itself determines the most appropriate functional form of the relationship. Also step (c) is considerably simplified.

a) First all the investor need do is to determine the two variables they believe are somehow related to each other. Quite important is the fact that there is no causality in the sense that one variable is not labelled the ‘dependent variable’ and the other the ‘independent variable’. In short, the direction of causality can flow both ways;

e.g. (CompanyA's Stock Price) [symbol] (US GDP).

b) Rather than specifying the correct functional form, the investor need only set the threshold level at which they ‘train’ the algorithm to screen good results from bad.

c) Finally, the expertise required by the investor in interpreting the output is much less restrictive using this technique than time-series analysis as the diagnostic tests come in the form of a simple ‘actual versus predicted’ outcome from which they can purview how the model has fitted the data in terms of its out-of-sample prediction in the past. It is here that the adaptive nature of the market may pose a problem but most neural-network techniques allow the correct functional form to alter over time so any consistent over or under prediction by the model for a period of time results in a gradual adjustment to the functional form. Importantly however, this only occurs in an ex-post fashion and is not considered from an ex-ante perspective.

iii) Embodiments of the Present Invention

Here there is less onus on the investor in terms of prior expertise when compared to the time series analysis or neural network techniques described above.

a) All the investor need do is to load in the information ‘byte’ they are most interested in.

e.g. (US GDP).

b) Up hitting ‘Go’ the algorithm automatically sorts all the associative historical information with this information byte and presents the results to the user in the form of a 3-D informational radix diagram—the strongest relationships toward the centre and the weaker toward the periphery—with time represented along the vertical scale.

c) Upon selecting yes to the prompt ‘Do you want to Search for Investment Recommendations Consistent With this Informational Genome?’ and then selecting their desired degree of accuracy, the algorithm automatically generates a list of all associative investment performances, their associated probability of success (given the present informational environ) together with allowance for the adaptive nature of financial markets in potentially altering the response function in the future. In contrast to traditional neural network techniques/evolutionary algorithms, the embodiments of the invention may be predictive in their interpretation of how markets adapt. Further, the embodiments of the invention may also be associative in their information search. That is, they are not looking for history exactly repeating itself in making certain investment forecasts but rather they look for a similar sequences of associative information to what has occurred in the past.

Thus features and advantages of embodiments of the invention can be summarised as:

The treatment of information as the outcome of an adaptive bioinformatics-based/evolutionary process within financial markets where both the microfoundation structure of information and the associations between replacement information signals is considered.

The use of evolutionary algorithms upon data arranged according to bio-informatic principles to identify ordered clusters of associative information commensurate with certain asset price outcomes and to make probabilistic projections of such outcomes known via user software.

The use of evolutionary algorithms upon data arranged according to bio-informatic principles to identify ordered clusters of associative information commensurate with certain asset price outcomes and allow for the adaptive nature of financial agents in responding to this information before making probabilistic projections of certain asset price outcomes known via user software.

The historical data mapped by the method may be thought of as an informational genome—the equivalent of the human genome. Thus, the method may be thought of as imposing the structure of bioinformatics onto financial data.

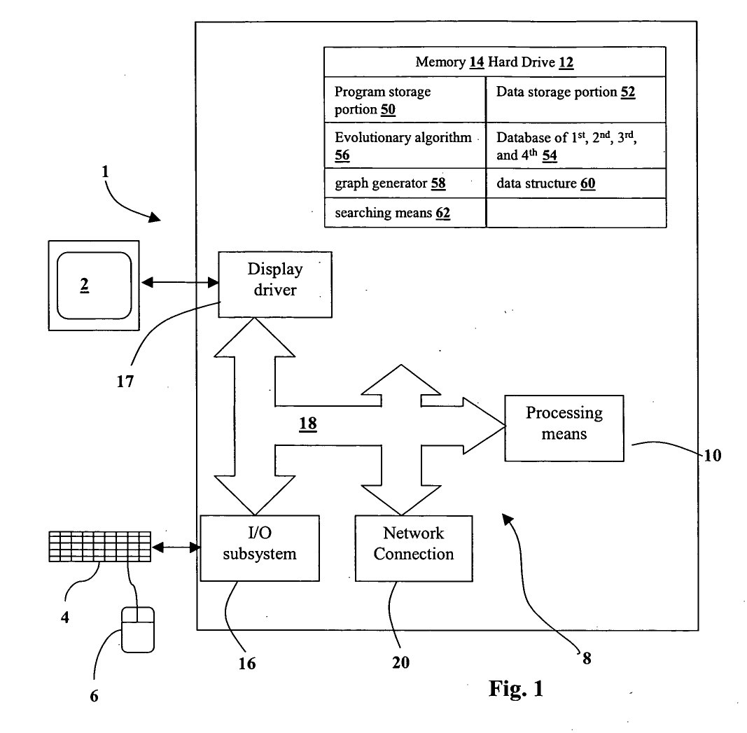

The computer system 1 shown in FIG. 1 comprises a display means 2, in this case an LCD (Liquid Crystal Display) monitor, a keyboard 4, a mouse 6 and processing circuitry 8. It will be appreciated that other display means such as LEP (Light Emitting Polymer), CRT (Cathode Ray Tube) displays, projectors, televisions and the like may be equally possible.

The processing circuitry 8 comprises a processing means 10, a hard drive 12 (containing a store of data), memory 14 (RAM and ROM), an I/O subsystem 16 and a display driver 17 which all communicate with one another, as is known in the art, via a system bus 18. The processing means 10 typically comprises at least one INTEL PENTIUM series processor, (although it is of course possible for other processors to be used) and performs calculations on data. The other processors may include processors such as the AMD™ ATHLON™, POWERPC™, DIGITAL™ ALPHA™, and the like.

The hard drive is used as mass storage for programs and other data. The memory 14 is described in greater detail below.

The keyboard 4 and the mouse 6 provide input means to the processing means 10. Other devices such as CDROMS, DVD ROMS, scanners, etc. could be coupled to the system bus 18 and allow for storage of data, communication with other computers over a network, etc. Any such devices may then comprise further input means.

The I/O (Input/Output) subsystem 16 is arranged to receive inputs from the keyboard 4 and from the processing means 10 and may allow communication from other external and/or internal devices. The display driver 17 allows the processing means 10 to display information on the display 2.

The processing circuitry 8 further comprises a transmitting/receiving means 20, which is arranged to allow the processing circuitry 8 to communicate with a network. The transmitting/receiving means 20 also communicates with the processing circuitry 8 via the bus 18.

The processing circuitry 8 could have the architecture known as a PC, originally based on the IBM™ specification, but could equally have other architectures. The processing circuitry 8 may be an APPLE™, or may be a RISC system, and may run a variety of operating systems (perhaps HP-UX, LINUX, UNIX, MICROSOFT™ NT, AIX™, or the like). The processing circuitry 8 may also be provided by devices such as Personal Digital Assistants (PDA's), mainframes, telephones, televisions, watches or the like.

It will be appreciated that although reference is made to a memory 14 it is possible that the memory could be provided by a variety of devices. For example, the memory may be provided by a cache memory, a RAM memory, a local mass storage device such as the hard disk 12, any of these connected to the processing circuitry 8 over a network connection such as via the transmitting/receiving means 20. However, the processing means 10 can access the memory via the system bus 18, accessing program code to instruct it what steps to perform and also to access the data samples. The processing means 10 then processes the data samples as outlined by the program code.

The memory 14 is used to hold instructions that are being executed, such as program code, etc., and contains a program storage portion 50 allocated to program storage. The program storage portion 50 is used to hold program code that can be used to cause the processing means 10 to perform predetermined actions.

The memory 14 also comprises a data storage portion 52 allocated to holding data and in embodiments of the present invention in particular comprises a database of 1^{st}, 2^{nd}, 3^{rd}, and 4^{th} moments 54.

In one embodiment the invention is embodied in a software program written in a combination of programming languages—Microsoft Visual C++, Microsoft Visual Basic, and Microsoft Access. This embodiment is loaded onto a users PC via a Microsoft Visual Basic setup.exe file and once installed, users can download regular data updates, using the network connection 20, from a variety of sources—including (but not exclusive to) Datastream, Reuters, Factset, and Bloomberg. In general, any source of data providing data in the correct format may be used.

Data is comprised of economic information, asset price information and other market relative information. Each asset price series is defined in terms of ‘moments’. ‘Moments’ may be thought of as the characteristics most investors take for granted in assessing a given asset. For example:
1^{st} moment=an asset's return performance;
2^{nd} moment=an asset's risk (its standard deviation);
3^{rd} moment=an asset's skew; and
4^{th} moment=an asset's kurtosis.

A summary of each of these moments is presented below.

1^{st} Moment-Return

By far the simplest technique in asset screening. Investors often opt for measurement in terms of simple arithmetic returns (average % return over a given time period) whereas the generally accepted correct methodology in the finance world is geometric return (which takes into account the compounding nature of return over time)—at least in the ex-post sense. An historic arithmetic return is generally higher (if it is positive, lower if it is negative) than a historic geometric return as the former contains the endogenous compounding element. The formula's for constructing both geometric and arithmetic returns are detailed below (with the geometric approach being used in some embodiments of the invention).

$$\begin{matrix}Average Return = {\sum }_{t = 1}^{T} \frac{{r}_{it}}{T} \\ Geometric Return = {[ {\prod }_{t = 1}^{T} ( 1 + {r}_{it} ) ]}^{\frac{1}{T}} - 1\end{matrix}$$

2^{nd} Moment-Risk (Standard Deviation)

This is again, an asset screening taxonomy device. Risk is defined as the standard deviation of asset returns (whatever time period these returns are measured in for example—daily, weekly, monthly, annual terms or other time period). The ‘standard’ formula for standard deviation is

$$S tan dard Deviation = \sqrt{\frac{{n \sum }_{t = 1}^{T} {x}^{2} - {( {\sum }_{t = 1}^{T} x )}^{2}}{n ( n - 1 )}}$$

this is the formula used in some embodiments of the invention.
3^{rd} Moment-Skewness

Skewness characterizes the degree of asymmetry of a distribution around its mean. Positive skewness indicates a distribution with an asymmetric tail extending toward more positive values. Negative skewness indicates a distribution with an asymmetric tail extending toward more negative values. Skewness is measured in some embodiments of the invention as follows

$$Skew = \frac{n}{( n - 1 ) ( n - 2 )} {\sum }_{t = 1}^{3 mths} {( \frac{{R}_{i} - {Avg [ {R}_{i} ]}_{t ↔ 3 mths}}{{σ}_{t ↔ 3 mths}} )}^{3} .$$

4^{th} Moment-Kurtosis

Kurtosis characterizes the relative ‘peaked’ or ‘flat’ nature of a distributional form for asset returns relative to the normal distribution. Positive kurtosis indicates a relatively peaked distribution. Negative kurtosis indicates a relatively flat distribution. There are many different ways to measure kurtosis—for example Hurst exponents, QQ plots, measurements of scale are all suitable. The approach undertaken in some embodiments of the invention is detailed below:

$$Kurtosis = ( \frac{n}{( n - 1 ) ( n - 2 ) ( n - 3 )} {\sum }_{t = 1}^{3 mths} {( \frac{{R}_{i} - {Avg [ {R}_{i} ]}_{t ↔ 3 mths}}{{σ}_{t ↔ 3 mths}} )}^{4} \} - \frac{3 {( n - 1 )}^{2}}{( n - 1 ) ( n - 2 )} .$$

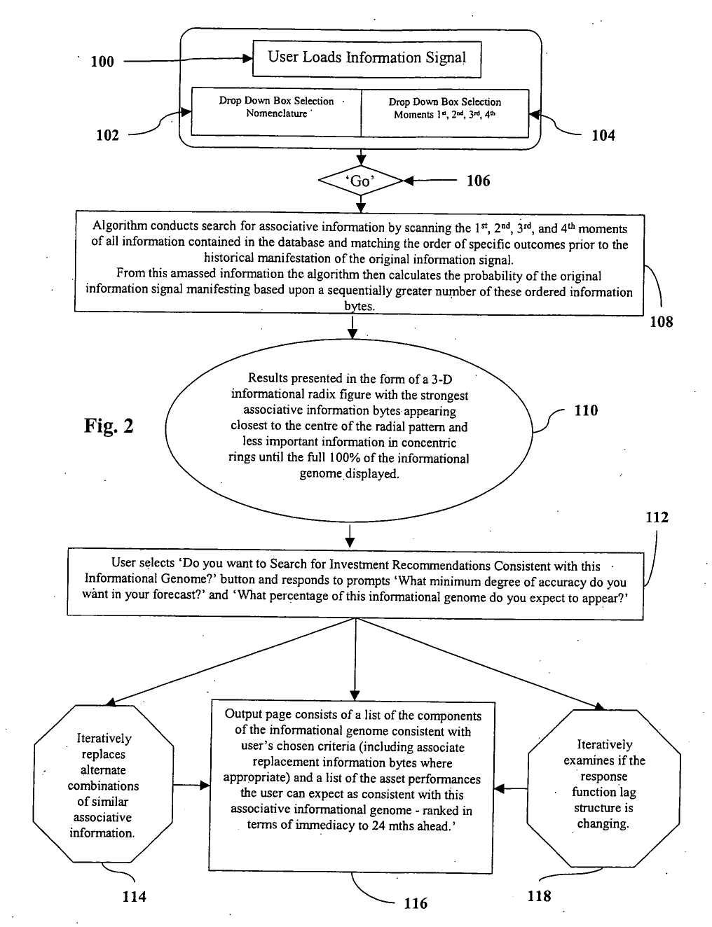

The algorithmic flow of the software program is presented in the attached FIG. 2 and discussed in detail below.

Upon entering the software, the user is prompted to load the information signal 100 from which they wish to assess the investment implications. This is done by selecting from the array of choices presented from a drop-down menu of possible information signal options.

The information signal drop-down menu comprises both a description of the information signal itself 102—in terms of its nomenclature—and the type of signal 104-1^{st} moment increasing/decreasing, 2^{nd} moment increasing/decreasing etc. The user may also choose the forecast periodicity over which the algorithm will conduct its signal/output association search—or alternately, the user may elect for the algorithm itself to select which signal/output responses are strongest over variable periodicities.

Once the user has selected an information signal for processing and pressed the ‘Go’ 106 button the 1^{st} stage 108 of the evolutionary algorithm begins to run. During this 1^{st} stage process the algorithm scans, using the searching means 62, the database of 1^{st}, 2^{nd}, 3^{rd}, and 4^{th} moments of all information contained in the database and matches the order of specific outcomes prior to the historical manifestation of the original information signal.

From this amassed information the algorithm then calculates the probability of the original information signal manifesting based upon a sequentially greater number of these ordered information bytes appearing.

The results of this probabilistic outcome search ate then presented 110 by the graph generator 58, to the user in the form of a 3-D informational radix figure with the strongest associative information bytes (relative to the original information signal the user has loaded) appearing closest to the centre of the radial pattern and then sequentially less important information appearing in concentric rings. Time is represented by a movement up the vertical scale until the full 100% of the informational genome of the specific information signal the user initially loaded is illustrated. At times these are ordered information bytes appear in meme formation as each byte is associate with the presence of other bytes.

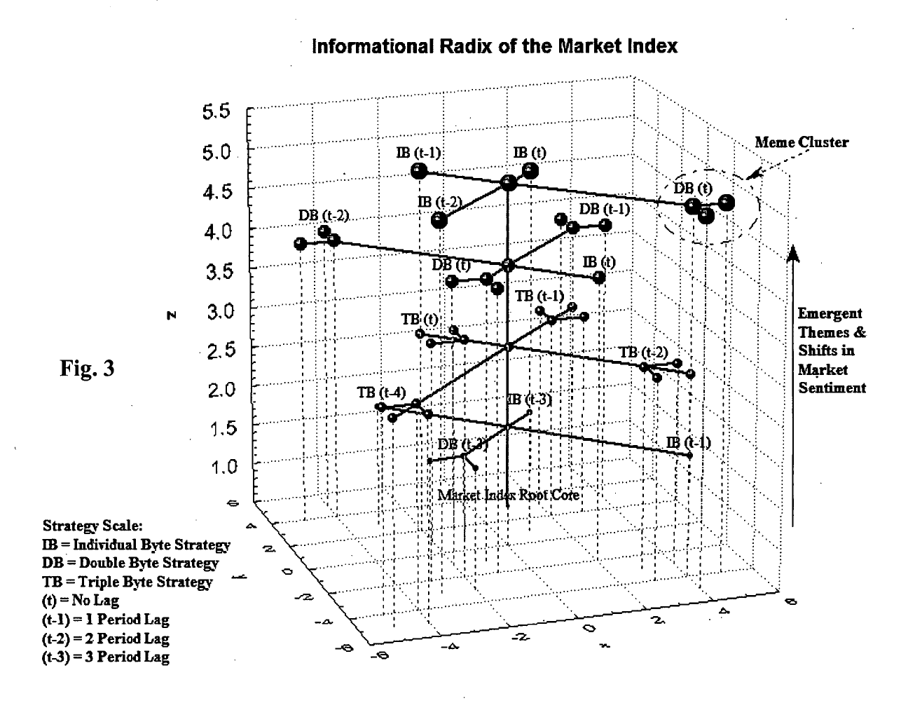

An example of such a radix Figure is shown in FIG. 3. This concludes stage 1 of the algorithm. A fuller description of the radix can be found hereinafter, but to avoid confusion stage 2 of the algorithm will now be described.

Before stage 2 of the algorithm is enacted to run, the user must depress the ‘Do you want to Search for Investment Recommendations Consistent with this Informational Genome?’ button contained on the output page displaying the informational radix figure.

Upon selecting this option the user is then presented with a prompt page ‘What minimum degree of accuracy do you want in your forecast?’ where a dynamic sliding scale is presented where the user can choose from a range of 0 to 100%. They are also presented within this prompt page a second question ‘What percentage of this informational genome do you expect to appear?’ where again, a dynamic sliding scale is presented where the user can choose from a range of 0 to 100%. This is represented as step 112 in FIG. 2.

Once the user has selected their minimum accuracy tolerance band and the percentage of the informational genome they expect to appear, stage 2 of the algorithm begins to run by initially searching for all historical precedents where the ‘percentage of the informational genome’ criteria are satisfied. In doing so, many of the forward-looking components close to the centre of the informational radix are generally selected as a large component of these observations immediately satisfy a ‘100% of the informational genome’ criteria and, given their proximity to the centre of the figure, they are also strongly associative—thus satisfying the users accuracy tolerance level. The search algorithm iteratively replaces alternate combinations of similar associative information—so defined by their presence on the informational radix diagram and similar nomenclature (index classification) and 1^{st}, 2^{nd}, 3^{rd}, and 4^{th} moments. This is shown in step 114 of FIG. 2. In undertaking this information ‘byte’ replacement the algorithm ensures that the user's selected ‘percentage of the informational genome’ criteria is satisfied.

The embodiment of the invention being described here then sequentially screens radially outwards. However, generally less of these observations are represented in the final output page as they are—by definition—less associative with the selected asset's performance.

Using these chosen (associative information) epochs, the algorithm then examines the commensurate monthly asset performance on a rolling basis 24 months forward. This is shown in step 116 of FIG. 2.

Reference is made above to a 24 month time period. The skilled person will appreciate that this time period, although perhaps the preferred time period, is illustrative only and other time periods may be used. For example roughly any of the following non-exhaustive list may be suitable: 6 m, 12 m, 18 m, 20 m, 28 m, 30 m, 36 m, 42 m, or any period in between.

Comparing these monthly performances vis-à-vis the aggregate number of associative epochs where the ‘percentage of the informational genome’criteria has been met enables the calculation of probabilities for the occurrence of certain asset price performances. These are then selectively screened against the user's minimum accuracy tolerance band.

In conducting sequential string search, the embodiment of the invention being described here screens not only exact memetic representations but also for similar memetic representations.

For example, a decrease in the 1^{st} moment of the index for Bank America (BA) may be highly associative with a decrease in the 1^{st} moment of the index for Merrill Lynch (MER). So the similar meme that the invention derives in predicting a particular asset's price performance may read GE/MER/MSFT rather than the purely historically correct GE/BA/MSFT.

However, before providing the user with the results of this forward-looking probabilistic outcome search the algorithm uses an iterative step technique to examine if the lag structure between the selected percentage of the informational genome appearing and certain asset price outcomes manifesting is actually altering through time—in a manner consistent with the adaptive nature of financial markets. In short, investors may learn to associate a signal from MER with BA because the two have been associative in the past. This is shown in step 118 of FIG. 2.

If the lag structure is indeed changing, then the algorithm takes this into account in generating its forward-looking probabilistic outcome results. It does this by estimating the functional form of the pace of adaptation by financial market agents to the specific information signals contained in the informational genome. The algorithm then adjusts its forward projections for asset performance accordingly before finally presenting the output to the user.

The contribution of this embodiment of the invention is that all these calculations—identification of both prospective and historical information association, the identification of the correct functional form for this relationship, and the identification of the lag structure between initial information signal and a sequence of related events occurring is all automatically done for the user. The reason that this can be done is that the premise that information combines in a bioinformatics/evolutionary manner is adopted and by doing so it is possible to modify existing evolutionary algorithms to make them consistent with bioinformatics principles. By doing so, it is possible to estimate the functional form for the adaptive nature in which investors are changing their responses to certain information stimuli and directly incorporates such adaptation into its forward projections. These forward projections may be presented in the final output page.

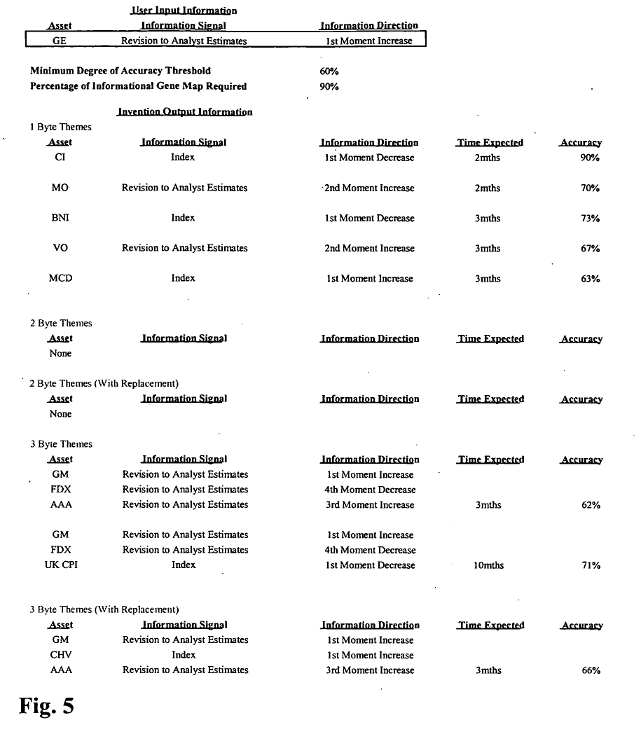

The output page that is finally presented to the user contains a list of the components of the informational genome consistent with their chosen criteria (including associate replacement information bytes where appropriate), alongside a list of the asset performances the user can expect as consistent with this associative informational genome—ranked in terms of immediacy to (at its furthermost projection) 24 months ahead. An example of a typical output page is shown in FIG. 5.

In addition, the user is also presented with the actual probabilities calculated by the algorithm (consistent with the criteria of screening for results only above the threshold the user has imposed) of each of these asset performances occurring. This concludes stage 2 of the algorithm.

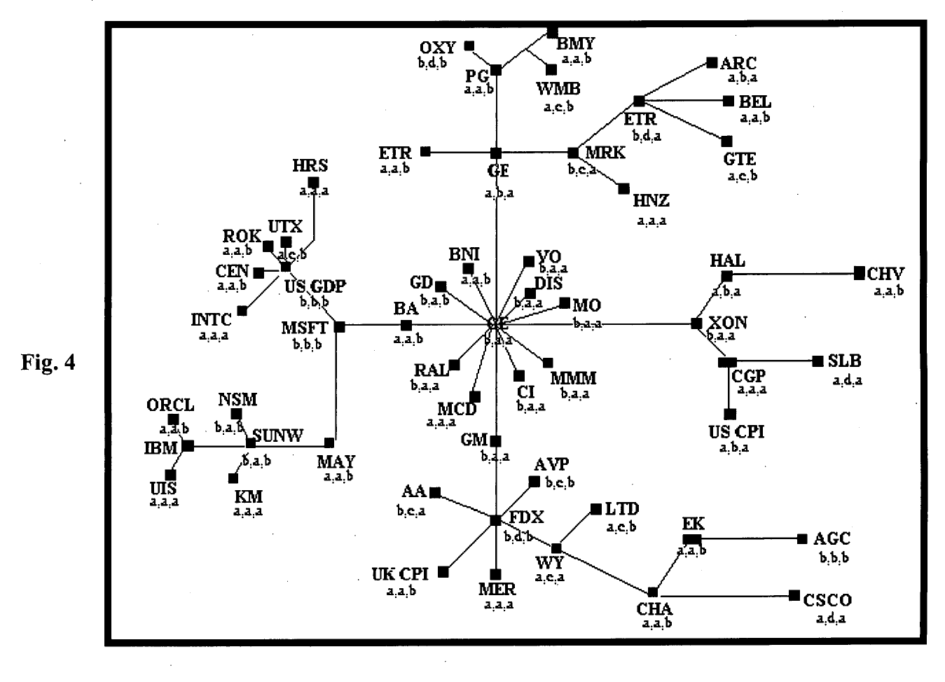

As discussed above, the 1st page of output presented to the user once they load in the information signal (byte) that they wish to analyse than then selected the ‘Go’ button is a 3-D informational radix figure—or ‘informational genome’ as defined in the invention an example of which is shown in FIG. 3. In the example shown in FIG. 4 a simulation has been run for a consensus analyst upgrade of the US stock known as Company B (GE). There is a lot of information presented in this chart so it is necessary to use colours (not visible here), abbreviations and scale to inform the user of how the information ‘bytes’ effectively bind together to form memes and then themes. Each of these legends will be dealt with below.

Scale

The most strongly associative outcomes (those with the highest probability of occurring—as calculated by the invention) are recorded closest to the centre of the 2-D cross-sectional representation of the informational radix.

If a sequence of events (or ‘information string’ as defined in the invention) is recorded as occurring in response to a consensus analyst upgrade of GE, then these are represented by successive nodes radiating out from the centre of the Figure.

Again, those information bytes (some of which are clustered into memes) with the highest probability of occurring are recorded closest to the centre of the Figure with sequentially less likely outcomes toward the periphery.

These ‘conditional’ probabilities as they are known are calculated in standard Bayesian fashion.

The totality of an information string is labelled as an ‘informational genome’ with alterations in themes being identified (as per the schematic representation of the informational radix) by a demonstrable change in the actual structure of the 3-D informational radix along its vertical scale.

Abbreviations for Cross-sectional Representation of 3-D Informational Radix

The sequence of letters below each of the asset and economic mnemonics (representing industry standard abbreviations of stock exchange and government statistical reported data) conveys to the user the information associated with each byte.

The first letter illustrates the dataset. For the simulation the datasets have been confined to index data and consensus analyst estimate data so an ‘a’ represents ‘index’ and a ‘b’ represents ‘consensus analyst estimates’.

The second letter represents the moment—in accordance with the above. So an ‘a’ represents the 1^{st} moment, a ‘b’ represents the 2^{nd} moment, a ‘c’ the rd th 3^{rd} moment and a ‘d’ the 4^{th} moment.

The third letter is a representation of whether the particular moment is increasing or decreasing. An ‘a’ represents an increasing moment, a ‘b’ a decreasing moment.

Colours

Colours provide a signal as to the time period (lag structure) of when associated information with the user's initial input occurs.

Pink=0-3 mths prior, Red=0-3 mths after, Yellow=3-6 mths after, Green=6-12 mths after, Blue=12-18 mths after. Of course, any other colours would be possible and these have been chosen for illustrative purposes only.

These colours are not apparent in FIG. 3, but the types of colours to be expected in the Figure will be apparent to the skilled addressee of the specification.

A legend explaining all the above is generated dynamically during each simulation and presented as part of this ‘1^{st} Stage’ output page. Furthermore by moving their cursor over the screen the user is able to obtain detailed information about each information byte—consistent with the above legend schemata. This is known as a ‘mouse-over’ facility.

Should the user wish to proceed they must depress the ‘Do you want to Search for Investment Recommendations Consistent with this Informational Genome?’ button contained on the output page displaying the 3-D informational radix figure.

Upon doing so, they are then presented with a prompt page ‘What minimum degree of accuracy do you want in your forecast?’ where a dynamic sliding scale is presented where the user can choose from a range of 0 to 100%. They are also presented within this prompt page a second question ‘What percentage of this informational genome do you expect to appear?’ where again, a dynamic sliding scale is presented where the user can choose from a range of 0 to 100%.

Appendix I

| | |
|---|---|
| Evolutionary Biology | Evolutionary Finance |

GENOTYPE

| | | | |
|---|---|---|---|
| LEVEL 1 | Bases (C, A, G, T) | | Base |
| | Four bases make up the double-stranded molecule | | The fundamental building blocks of all informa- |
| | known as DNA (deoxyribonucleic acid) that looks | | tion. Bytes are encoded into sequences is accor- |
| | is comprised of a sugar-phosphate backbone and | | danc e For financial information, bytes are encod- |
| | numerous base chemicals attached in pairs. These | [symbol] | ed in the form of specific action responses-Buy |
| | ‘bases’ as they are known, effectively make up | | (B), Neutral (N), and Sell (S). There is both a |
| | the stairs of the spiraling staircase and come in | | contemporaneous (1^{st} letter) and latent (2^{nd} letter) |
| | the form of cytosine (C), adenine (A), guanine | | aspect to byte information. So according to Evo- |
| | (G) and thymine (T). The bases act as letters of | | lutionary Finance principles, a byte can take |
| | the genetic alphabet and it is through their | | either of nine forms: BB, BN, BS, NB, NN, NS, |
| | sequencing that genes are formed. For example, | | SB, SN, SS. For financial information a byte can |
| | around 3 billion bases arranged in sequence form | | refer to an analyst's research report, a financial |
| | the approximately 35,000 genes trhat comprise | | commentators story or even an official release |
| | the human DNA molecule. Within this molecule, | | from a government statistical bureau. Some bytes |
| | all the information required to ‘build’ each human | | have more ‘externality potential’ than others. That |
| | being is stored. | | is, thay have a superior ability to bind information |
| | | | together. |
| LEVEL 2 | Gene | | Meme |
| | Comprised of base sequences, genes are the | | Comprised of byte sequences, memes are the |
| | functional units of hereditary. Genes store | | functional units for the way information is stored |
| | information which is then converted into signals | [symbol] | and relayed. Memes unlock the latent information |
| | for building a specific protein and thus cells | | in bytes. Just as particular letters of the alphabet |
| | governing everything from vital organ tissue to | | make up certain words, so too do particular bytes |
| | hair color. | | form certain memes. Some memes are stronger in |
| | | | their impact than others but without every |
| | | | necessary component of a memetic sequence in |
| | | | place, the latent information within constituent |
| | | | information bytes will go untapped. |
| LEVEL 3 | DNA | | Theme |
| | First described by James Watson and Franmcis | | An agglomeration of memes, a theme is a broad |
| | Crick in 1953, DNA represents the complete | | reference given to a group of memes (sometimes |
| | aggregation of an organism's genetic information. | [symbol] | from a variety of assets). Ths classification of |
| | It is comprised of the entire gene sequence which, | | alternate memetic information into associative |
| | in turn, represents the entire base sequence. | | thematic groupings helps humans encode |
| | | | information bytes (and their larger form of |
| | | | agglomeration-memes) for storage and retrieval |
| | | | within the human brain. A new theme is |
| | | | announced with the publication of a particularly |
| | | | seminal information byte-one with exceptionally |
| | | | strong externality potential. |
| LEVEL 4 | Chromosome | | Sentiment (Bull/Bear) |
| | Part of the cell that contains genetic information. | | An aggregation of themes that comprise an over- |
| | It is ccomprised of a tightly packed coil of DNA- | [symbol] | all interpretation of information toward a given |
| | humans having 46 such tightly packed DNA coils | | subject (in our case, the market) at a given point |
| | in each cell nucleus. | | in time. |

PHENOTYPE

| | | | |
|---|---|---|---|
| LEVEL 5 | Cell | | Asset Prices |
| | The basic structural and functional unit of all | | The object viaa which one's interpretation of all |
| | organ isms. The nucleus of a cell contains all the | | financial information at a given point in time is |
| | genetic information. Collections of cells form an | [symbol] | embodied. The most readily observable response |
| | organissm's tissues, blood and organs. | | to changes in an investor's perception of |
| | | | the informational state is alterations in asset |
| | | | prices. |
| LEVEL 6 | Organisam | | Index/Market |
| | What we see as the ‘final product’ of genetic | | An agglomeration of assets into specific |
| | information. As the highest level of aggregation | | (meaningful) groups. When most people refer to |
| | of the encoded information, it is also the most | [symbol] | the ‘market’ they are usually referring to an in- |
| | obvious physical manifestation of the genetic | | dex (e.g. S & P 500) or a group of indices (e.g. |
| | blueprint. | | global bonds). |

1. A method of predicting changes in a value associated with at least one financial asset wherein information relevant to the asset is modelled as a plurality of informational components, the informational components being combined into a plurality of sequences and the sequences being combined into an agglomeration of sequences and the information relevant to the asset is processed by an adaptive bioinformatics-based evolutionary process wherein the output of the evolutionary process is a prediction of the future performance of the asset.

2. A method according to claim 1 in which the evolutionary process develops sequences from a plurality of informational components as it is run.

3. A method according to claim 1 in which the evolutionary process develops agglomerations of sequences from a plurality of sequences as it is run.

4. A method according to claim 1 which searches the information relevant to an asset for combinations of informational components in order predict the future performance of that asset.

5. A method according to claim 4 which uses sequences in which the combinations of informational components located in the search occur in order to predict future performance.

6. A method according to claim 4 which uses agglomerations in which the combinations of informational components located in the search occur in order to predict future performance.

7. A method according to claim 4 which is arranged to generate a graphical output showing the results of the search in which informational components are grouped according to the relevance of that asset to the asset which is having its performance predicted.

8. A method according to claim 1 in which the adaptive bioinformatics-based evolutionary process comprises an evolutionary algorithm based upon data arranged according to bio-informatic principles.

9. A method according to claim 8 in which the evolutionary algorithm is used to identify ordered clusters of associative informational components commensurate with certain asset price outcomes and to make probabilistic projections of such outcomes.

10. A method according to claim 9 which also comprises the use of the evolutionary algorithm to identify ordered clusters of associative information commensurate with certain asset price outcomes and allow for the adaptive nature of financial agents in responding to this information before making probabilistic projections of certain asset price outcomes.

11. A computer system arranged to predict changes in a value associated with at least one financial asset, the system comprising a memory arranged to store historical data structured according to bio-informatic principles with information relevant to an asset being modelled as a plurality of informational components, the informational components being combined into a plurality of sequences and the sequences being combined into an agglomeration of sequences, the system further comprising a processor arranged to run an evolutionary algorithm which processes the historical data in order predict the change in value of the at least one asset.

12. A system according to claim 11 which comprises a search means arranged to search the information relevant to an asset for predetermined combinations of informational components.

13. A system according to claim 12 which comprises a graph generator arranged to generate a graphical output of the results of the search.

14. A data structure providing information relevant to a financial asset, the data being structured as a series of informational components, with informational components being combined into a plurality of sequences and the sequences being combined into a plurality of agglomerations of sequences.

15. A machine readable medium containing instructions which when read by a computer cause that computer to perform the method of claim 1.

16. A machine readable medium containing instructions which when read by a computer cause that computer to function as the computer system of claim 11.

17. A machine readable medium containing data providing the data structure of claim 14.

18. A method of predicting changes in a value associated with at least one financial asset comprising modelling data related to the asset according to bioinformatic principles and processing the data with an evolutionary algorithm.

19. A method of predicting changes in a value associated with a least one financial asset comprising modelling data related to the asset as a plurality of informational components, the informational components being combined into a plurality of sequences and the sequences being combined into an agglomeration of sequences and processing the data using an evolutionary algorithm the output of which is used to predict the change in value of the asset.
